(19) United States
(12) Patent Application Publication
(10) Pub. No.: US 2026/0118658 A1
(43) Pub. Date: Apr. 30, 2026

(54) ACTUATING DEVICE

(71) Applicant: Coretronic MEMS Corporation, MIAOLI COUNTY (TW)

(72) Inventor: Hung-Yu LIN, MIAOLI COUNTY (TW)

(21) Appl. No.: 18/932,670

(22) Filed: Oct. 31, 2024

(30) Foreign Application Priority Data
Oct. 28, 2024 (TW) 113141150

(51) Int. Cl. G02B 26/08

(52) U.S. Cl. CPC G02B 26/0858

(57) ABSTRACT

The application provides an actuating device including a micro-mirror and two wing-shaped actuators. The micro-mirror may swing around an axial line. The two wing-shaped actuators encompass the micro-mirror and are separate from the micro-mirror. Each wing-shaped actuator includes two separate actuating units, a supporting part and a torsional part. The two actuating units are respectively disposed on two sides of the axial line, and there is an interval between the two actuating units. At least one part of the supporting part is disposed in the interval and is connected to the two actuating units. At least one part of the torsional part is disposed in the interval and is connected to the supporting part and the micro-mirror. The four actuating units respectively receive driving signals to drive the micro-mirror to swing. By the aforementioned configuration, pure torsion is provided to the micro-mirror, and a non-linear response is avoided.

### CROSS REFERENCE TO RELATED APPLICATION

The disclosure claims the priority benefit of Taiwan Patent Application Serial Number 113141150, filed on Oct. 28, 2024, the full disclosure of which is incorporated herein by reference.

### TECHNICAL FIELD

The disclosure is related to a technical field of semiconductor micro-electromechanical systems and is particularly related to a actuating device.

### RELATED ART

As semiconductor technologies daily advance, the semiconductor micro-electromechanical systems successfully develops. The applications of the semiconductor micro-electromechanical systems (micro-electromechanical systems, MEMS) are more various, e.g., the probe of an atomic force microscope, a microchannel, a scanning micro-mirror or a microsensor.

The scanning micro-mirror manufactured by the MEMS may be grouped into three categories: (1) an electrostatic scanning micro-mirror utilizes a finger parallel plate capacitor to generate electrostatic force by edge effects and converts the electrostatic force to the torsion to rotate the micro-mirror. (2) an electromagnetic scanning micro-mirror utilizes a sensing coil arranged on the structure to generate Lorentz force by altering an external magnetic field and converts the Lorentz force to the torsion to rotate the micro-mirror. (3) a piezoelectric scanning micro-mirror utilizes the characteristics of piezoelectric materials to generate stresses and converts the stresses to the torsion to rotate the micro-mirror by a composite film stack. Because the piezoelectric scanning micro-mirror has advantages such as a low driving voltage, no adsorption effects and no requirements for complicated mounting, the piezoelectric micro-mirror become the main developing technology of the micro-mirror.

The Related art section is only for enhancement of understanding of the background of the described technology and therefore “the related art” section may contain information that does not form the prior art that is already known to a person of ordinary skill in the art. Further, the information disclosed in the Related art section does not mean that one or more problems to be resolved by one or more embodiments of the disclosure was acknowledged by a person of ordinary skill in the art.

### SUMMARY

In light of the aforementioned descriptions, the disclosure provides an actuating device.

The actuating device provided by the disclosure includes a micro-mirror and two wing-shaped actuators. The micro-mirror may swing around an axial line. The two wing-shaped actuators encompass the micro-mirror and are separate from the micro-mirror. Each wing-shaped actuator includes two separate actuating units, a supporting part and a torsional part. The two actuating units are disposed on two sides of the axial line, and there is an interval between the two actuating units. At least one part of the supporting part is disposed in the interval and is connected to the two actuating units. At least one part of the torsional part is disposed in the interval and is connected to the supporting part and the micro-mirror.

In order for the aforementioned features and advantages of the disclosure to be more comprehensible, embodiments accompanied with drawings are described in detail below.

### BRIEF DESCRIPTION OF THE DRAWINGS

FIG. 1A depicts a 3D diagram of an actuating device according to one embodiment of the disclosure.

FIG. 1B depicts the top view diagram of the actuating device according to one embodiment of the disclosure.

FIG. 1C depicts the block diagram of the electronic components in the actuating device according to one embodiment of the disclosure.

FIG. 2 depicts the schematic diagram of the operation of the actuating device according to one embodiment of the disclosure.

FIG. 3 depicts a cross section diagram of an actuating device according to one embodiment of the disclosure.

FIG. 4 depicts the bottom view diagram of the actuating device according to one embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an actuating device including a micro-mirror and two wing-shaped actuators. The micro-mirror may swing around an axial line. The two wing-shaped actuators encompass the micro-mirror and are separate from the micro-mirror. Each wing-shaped actuator includes two separate actuating units, a supporting part and a torsional part. The two actuating units are disposed on two sides of the axial line, and there is an interval between the two actuating units. At least one part of the supporting part is disposed in the interval and is connected to the two actuating units. At least one part of the torsional part is disposed in the interval and is connected to the supporting part and the micro-mirror. By the configuration of the two wing-shaped actuators, pure torsion is inputted to the micro-mirror to avoid non-linear responses.

In order to clearly understand the operation mechanism of the actuating device of the disclosure, the following paragraphs will elaborate the operation mechanism of the actuating device of the disclosure by the embodiments and the accompanying drawings.

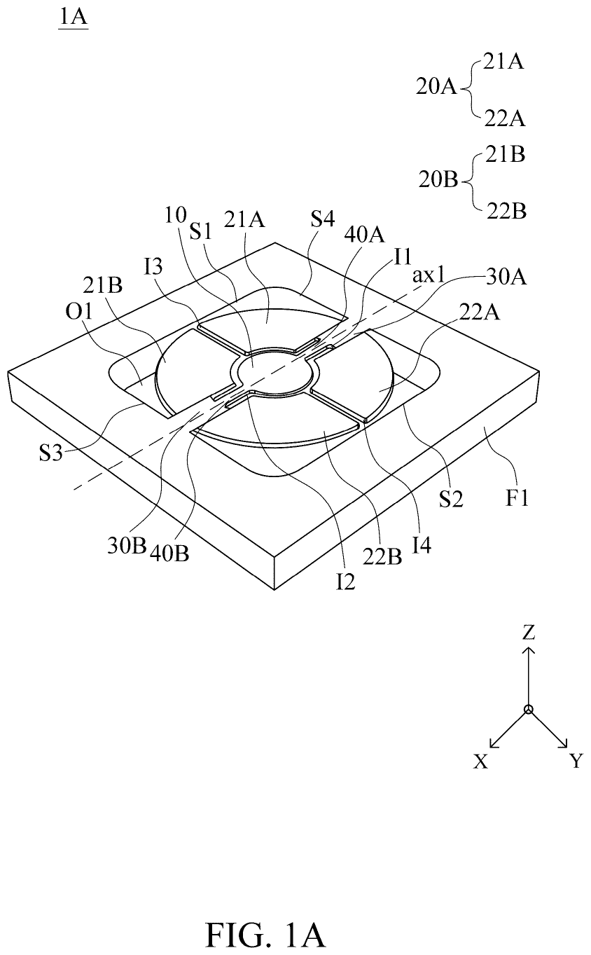

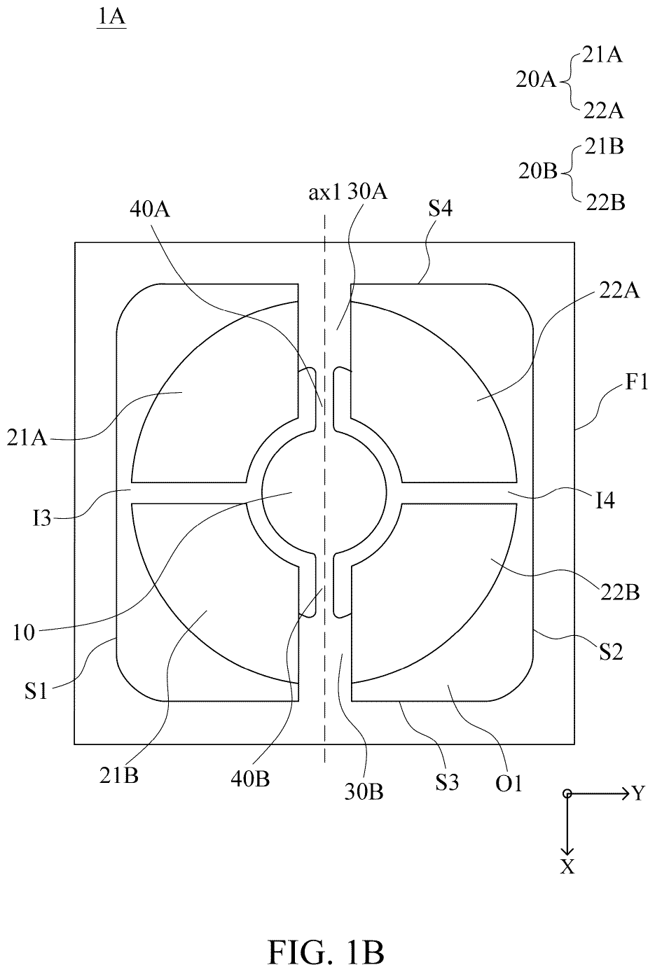

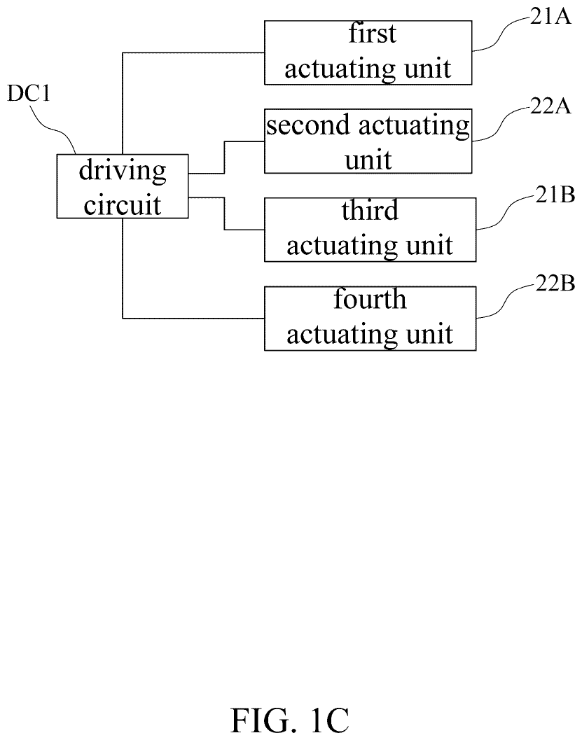

Please refer to FIG. 1A and FIG. 1B, which depict a 3D diagram of an actuating device according to one embodiment of the disclosure and the top view diagram of the actuating device according to one embodiment of the disclosure. As shown in FIG. 1A and FIG. 1B, the actuating device 1A includes a micro-mirror 10 and two wing-shaped actuators 20A and 20B. The two wing-shaped actuators 20A and 20B encompass the micro-mirror 10 and are respectively connected to the micro-mirror 10. The actuating device 1 further includes a frame body F1 configured to accommodate the two wing-shaped actuator 20A and 20B and the micro-mirror 10. Herein, Cartesian coordinate system X-Y-Z is provided to be favorable to describe the following components, the length direction of the frame body F1 is parallel to X-axis, the width direction of the frame body F1 is parallel to Y-axis, and the height direction of the frame body F1 is parallel to Z-axis.

The frame body F1 may be a rectangular frame body for example and have a first side S1, a second side S2, a third side S3, a fourth side S4 and an accommodation opening O1. The first side S1, the second side S2, the third side S3 and the fourth side S4 collaboratively define the accommodation opening O1, and the micro-mirror 10 and the two wing-shaped actuator 20A and 20B are disposed in the accommodation opening O1.

The micro-mirror 10 may be a circle reflector for example and lie in the center of the accommodation opening O1. An axial line ax1 is parallel to the X-axis and serves as the swinging axis of the micro-mirror 10. By driving the two wing-shaped actuators 20A and 20B, the micro-mirror 10 may swing around the axial line ax1 (e.g., parallel to the X-axis).

The two wing-shaped actuators 20A and 20B are separate from each other, are disposed in the accommodation opening O1 and encompass the micro-mirror 10. Specifically, the wing-shaped actuator 20A is disposed at the side of the micro-mirror 10 close to the fourth side S4, and the wing-shaped actuator 20B is disposed at the side of the micro-mirror 10 close to the third side S3, and the wing-shaped actuator 20A and the wing-shaped actuator 20B do not directly contact; in other words, the wing-shaped actuators 20A and 20B are disposed at the two opposite sides of the micro-mirror 10 and symmetrically disposed with respect to the micro-mirror 10, and for example, the symmetrical line of the wing-shaped actuators 20A and 20B is vertical to axial line ax1 (e.g., parallel to the Y-axis). The two wing-shaped actuators 20A and 20B are disposed at the peripheral side of the micro-mirror 10 and surrounds the micro-mirror 10; in other words, the two wing-shaped actuators 20A and 20B are disposed between the micro-mirror 10 and the frame body F1.

The wing-shaped actuator 20A includes a first actuating unit 21A and a second actuating unit 22A which are separate from each other, a supporting part 30A and a torsional part 40A. The first actuating unit 21A and the second actuating unit 22A are disposed at the two sides of the axial line ax1, and there is an interval I1 between the first actuating unit 21A and the second actuating unit 22A. The first actuating unit 21A and the second actuating unit 22A are respectively connected to the supporting part 30A and are separate from the micro-mirror 10. Specifically, the first actuating unit 21A and the second actuating unit 22A are disposed at the side of the micro-mirror 10 close to the fourth side S4, and the end surface of the first actuating unit 21A connected to the supporting part 30A and the end surface of the second actuating unit 22A connected to the supporting part 30A are respectively at the left side and the right side of the axial line ax1; there is an interval I1 between the end surface of the first actuating unit 21A connected to the supporting part 30A and the end surface of the second actuating unit 22A connected to the supporting part 30A, and the interval I1 is located on the axial line ax1 and corresponds to the fourth side S4. In addition, the first actuating unit 21A and the second actuating unit 22A are symmetrical to each other with respect to the axial line ax1.

The wing-shaped actuator 20B includes third actuating unit 21B [symbol] fourth actuating unit 22B which are separate from each other, a supporting part 30B and a torsional part 40B. The third actuating unit 21B and the fourth actuating unit 22B are disposed at the two sides of the axial line ax1, and there is an interval I2 between the third actuating unit 21B and the fourth actuating unit 22B. The third actuating unit 21B and the fourth actuating unit 22B are respectively connected to the supporting part 30B and are separate from the micro-mirror 10. Specifically, the third actuating unit 21B and the fourth actuating unit 22B are disposed at the side of the micro-mirror 10 close to the third side S3, and the end surface of the third actuating unit 21B connected to the supporting part 30B and the end surface of the fourth actuating unit 22B connected to the supporting part 30B are respectively at the left side and the right side of the axial line ax1; there is an interval I2 between the end surface of the third actuating unit 21B connected to the supporting part 30B and the end surface of the fourth actuating unit 22B connected to the supporting part 30B, and the interval I2 is located on the axial line ax1 and corresponds to the third side S3. In addition, the third actuating unit 21B and the fourth actuating unit 22B are symmetrical to each other with respect to the axial line ax1.

Because the wing-shaped actuator 20A and the wing-shaped actuator 20B are separate, the first actuating unit 21A and third actuating unit 21B are separate, there is an interval I3 between the end surface of the first actuating unit 21A not connected to the supporting part 30A and the end surface of the third actuating unit 21B not connected to the supporting part 30B, and the interval I3 corresponds to the first side S1; the second actuating unit 22A and the fourth actuating unit 22B are separate, there is an interval I4 between the end surface of the second actuating unit 22A not connected to the supporting part 30A and the end surface of the fourth actuating unit 22B not connected to the supporting part 30B, and the interval I4 corresponds to the second side S2. In other words, there are the interval I3 and the interval I4 between the wing-shaped actuator 20A and the wing-shaped actuator 20B. In addition, the symmetrical line of the wing-shaped actuators 20A and 20B extends from the first side S1 to the second side S2, the part of the symmetrical line of the wing-shaped actuators 20A and 20B lies in the interval I3 and the interval I4, and the intersection point (on the surface of the micro-mirror 10) of the symmetrical line of the wing-shaped actuators 20A and 20B and the axial line ax1 may be located on the geometric center of the micro-mirror 10 for example.

Because the first actuating unit 21A to the fourth actuating unit 22B are all separate from the micro-mirror 10 and the shape of the micro-mirror 10 is a circle, the end surface of the first actuating unit 21A close to the micro-mirror 10 is a circular arc surface, and the end surface of the second actuating unit 22A close to the micro-mirror 10, the end surface of the third actuating unit 21B close to the micro-mirror 10 and the end surface of the fourth actuating unit 22B close to the micro-mirror 10 are all the circular arc surfaces; correspondingly, the end surface of the first actuating unit 21A far away from the micro-mirror 10 is the circular arc surface, and the end surface of the second actuating unit 22A far away from the micro-mirror 10, the end surface of the third actuating unit 21B far away from the micro-mirror 10 and the end surface of the fourth actuating unit 22B far away from the micro-mirror 10 are all the circular arc surfaces. In addition, the first actuating unit 21A and the fourth actuating unit 22B may be symmetrically disposed with respect to the micro-mirror 10, and the second actuating unit 22A and the third actuating unit 21B may be symmetrically disposed with respect to the micro-mirror 10.

Furthermore, the first actuating unit 21A to the fourth actuating unit 22B may respectively generate bends by the deformation of piezoelectric materials, and the bends of the first actuating unit 21A to the fourth actuating unit 22B are respectively controlled by compressive stresses and tensile stresses to generate a moment of force on the axial line ax1, and the moment of force drives the micro-mirror 10 to swing. The details of swinging the micro-mirror 10 driven by the first actuating unit 21A to the fourth actuating unit 22B will be described in the paragraphs of explaining the operation mechanism of the actuating device.

The supporting part 30A is disposed in the interval I1 corresponding to the fourth side S4 and is connected to the first actuating unit 21A, the second actuating unit 22A, one end of the torsional part 40A and the fourth side S4 of the frame body F1. Specifically, one part of the supporting part 30A is located on the interval I1 corresponding to the fourth side S4 and is connected to the first actuating unit 21A, the second actuating unit 22A and the one end of the torsional part 40A; the other part of the supporting part 30A is located on the accommodation opening O1 and is connected to the fourth side S4 of the frame body F1. In other words, the supporting part 30A is disposed between the first actuating unit 21A and the second actuating unit 22A and is located on the axial line ax1, the first actuating unit 21A and the second actuating unit 22A connected to the supporting part 30A are separate, and the torsional part 40A is connected to the frame body F1 by the supporting part 30A. The first actuating unit 21A and the second actuating unit 22A are symmetrical to each other with respect to the supporting part 30A. The width of the supporting part 30A on the Y-axis is the distance between the end surface of the supporting part 30A connected to the first actuating unit 21A and the end surface of the supporting part 30A connected to the second actuating unit 22A and is equal to the value of the interval I1.

The supporting part 30B is disposed in the interval I2 corresponding to the third side S3, and is connected to the third actuating unit 21B, the fourth actuating unit 22B, one end of the torsional part 40B and the third side S3 of frame body F1. Specifically, one part of the supporting part 30B is located on the interval I2 corresponding to the third side S3 and s connected to the third actuating unit 21B, the fourth actuating unit 22B and the one end of the torsional part 40B; the other part of the supporting part 30B is located on the accommodation opening O1, and is connected to the third side S3 of the frame body F1. In other words, the third actuating unit 21B and the fourth actuating unit 22B connected to the supporting part 30B are separate, the supporting part 30A is disposed between the third actuating unit 21B and the fourth actuating unit 22B and is located on the axial line ax1, and the torsional part 40B is connected to the frame body F1 by the supporting part 30B. The third actuating unit 21B and the fourth actuating unit 22B are symmetrical to each other with respect to the supporting part 30B. The width of the supporting part 30B on the Y-axis is the distance between the end surface of the supporting part 30B connected to the third actuating unit 21B and the end surface of the supporting part 30B connected to the fourth actuating unit 22B and is equal to the value of the interval I2.

The supporting part 30A and the supporting part 30B are disposed at the two opposite sides of the micro-mirror 10 and are located on the axial line ax1; in other words, the supporting part 30A and supporting part 30B are symmetrically disposed with respect to the micro-mirror 10. The supporting part 30A and the supporting part 30B collaboratively support the micro-mirror 10, each actuating unit, the torsional part 40A and the torsional part 40B. By adjusting the width of the supporting part 30A and the width of the supporting part 30B, the coupling of mode shapes is effectively suppressed and the stresses on the supporting part 30A and supporting part 30B are significantly reduced, thereby improving the reliability of the actuating device.

It should be noted that under different driving conditions, the actuating device may operate in the different mode shapes such as an in-plane (in-plane) mode, a piston (piston) mode and a scan (scan) mode. Each mode shape corresponds to one operation frequency. If the operation frequencies corresponding to the two mode shapes are too close, it will lead to the aforementioned coupling of the mode shapes. When the coupling of the mode shapes happens, it would cause that the actuating device does not operate in the originally set target mode. In addition, the coupling of the mode shapes also affects the stress distribution of the actuating device so that the stresses are distributed in a non-ideal structural point (e.g., the structurally fragile part in the actuating device), and it would result in increasing the maximum stress of the actuating device. When the actuation frequency of the actuating device approaches the scanning frequency of the originally set target mode, the needed energy to rotate the micro-mirror 10 is generated on the torsional part 40A and the torsional part 40B so that the scanning angle of the actuating device may be magnified.

The torsional part 40A is disposed in the interval I1 corresponding to the fourth side S4, and the other end of the torsional part 40A is connected to the micro-mirror 10. Specifically, one part of the torsional part 40A is located on the interval I1 corresponding to the fourth side S4 and is connected to the supporting part 30A; the other part of the torsional part 40A is located on the peripheral side of the micro-mirror 10 to connect to the micro-mirror 10. In other words, the torsional part 40A is disposed at the side of the micro-mirror 10 close to the fourth side S4 and is located between the micro-mirror 10 and the supporting part 30A. The torsional part 40A transmits the moment of force generated by the first actuating unit 21A and the third actuating unit 21B to the micro-mirror 10 to drive the micro-mirror 10 to swing. The width of the torsional part 40A on the Y-axis is the distance between the right edge of the torsional part 40A on the axial line ax1 and the left edge of the torsional part 40A on the axial line ax1, and the width of the supporting part 30A on the Y-axis is greater than the width of the torsional part 40A on the Y-axis. The torsional part 40A is separate from the first actuating unit 21A and the second actuating unit 22A and is connected to the fourth side S4 of the frame body F1 by the supporting part 30A.

The torsional part 40B is disposed in the interval I2 corresponding to the third side S3, and the other end of the torsional part 40B is connected to the micro-mirror 10. Specifically, one part of the torsional part 40B is located on the interval I2 corresponding to the third side S3 and is connected to the supporting part 30B; the other part of the torsional part 40B is located on the peripheral side of the micro-mirror 10 to connect to the micro-mirror 10. In other words, the torsional part 40B is disposed at the side of the micro-mirror 10 close to the third side S3 and is located between the micro-mirror 10 and the supporting part 30B. The torsional part 40B transmits the moment of force generated by the second actuating unit 22A and the fourth actuating unit 22B to the micro-mirror 10 to drive the micro-mirror 10 to swing. The width of the torsional part 40B on the Y-axis is the distance between the right edge of the torsional part 40B on the axial line ax1 and the left edge of the torsional part 40B on the axial line ax1, and the width of the supporting part 30B on the Y-axis is greater than the width of the torsional part 40B on the Y-axis. The torsional part 40B is separate from (not directly connected to) the third actuating unit 21B and the fourth actuating unit 22B and is connected to the third side S3 of the frame body F1 by the supporting part 30B.

The torsional part 40A and the torsional part 40B are disposed at the two opposite sides of the micro-mirror 10 and is located on the axial line ax1; in other words, the torsional part 40A and the torsional part 40B are symmetrically disposed with respect to the micro-mirror 10. The torsional part 40A and the torsional part 40B undergo the stresses generated by the micro-mirror 10 during swinging. By adjusting the size of the torsional part 40A and the size of the torsional part 40B, the maximum stress of the actuating device is reduced in the case that the actuating device is operated on the same resonant frequency and the same scanning angle, thereby improving the reliability of the actuating device.

Please refer to FIG. 1C, which depicts the block diagram of the electronic components in the actuating device according to one embodiment of the disclosure. As shown in FIG. 1C, the actuating device 1A further includes a driving circuit DC1; the driving circuit DC1 is coupled to the first actuating unit 21A, the second actuating unit 22A, the third actuating unit 21B and the fourth actuating unit 22B and respectively provides driving signals to the first actuating unit 21A, the second actuating unit 22A, the third actuating unit 21B and the fourth actuating unit 22B. The driving signal received by the first actuating unit 21A and the driving signal received by the third actuating unit 21B are the same, and the driving signal received by the second actuating unit 22A and the driving signal received by the fourth actuating unit 22B are the same; in other words, the driving signals received by the two actuating units on the same side of the axial line ax1 are the same. The driving signal received by the first actuating unit 21A and the driving signal received by the second actuating unit 22A are different, and the driving signal received by the third actuating unit 21B and the driving signal received by the fourth actuating unit 22B are different; in other words, the driving signals received by the two actuating units on the two opposite sides of the axial line ax1 are different.

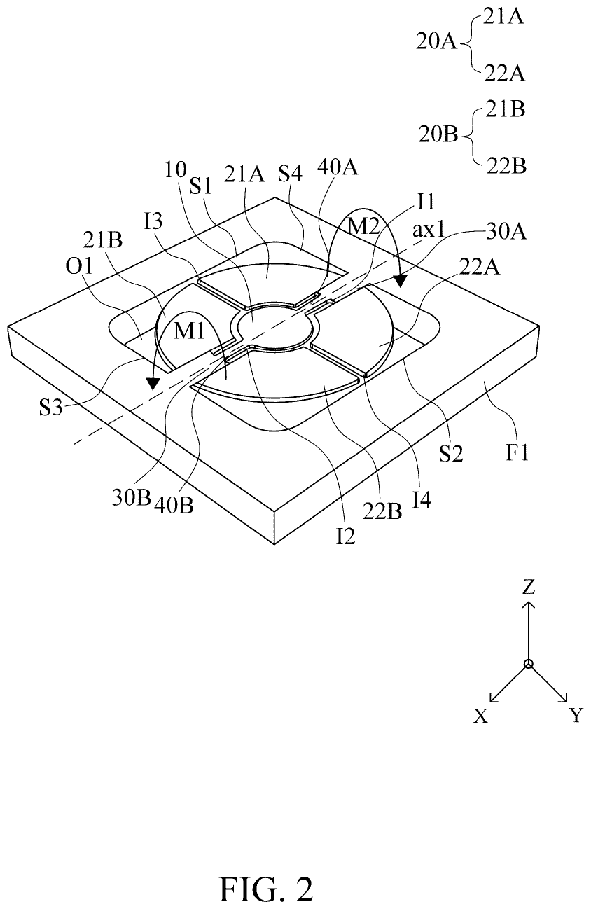

The following would introduce the operation mechanism of the actuating device. Please further refer to FIG. 2, which depicts the schematic diagram of the operation of the actuating device according to one embodiment of the disclosure. In order to clearly explain the mechanism of driving the micro-mirror 10 to rotate by the first actuating unit 21A to the fourth actuating unit 22B, the driving signal received by the first actuating unit 21A to the driving signal received by the fourth actuating unit 22B are described in advance as follows. The driving signal received by the first actuating unit 21A and the driving signal received by the third actuating unit 21B are the first driving signals; the first driving signal is a voltage signal and is denoted by M sin 2πft, wherein M is the amplitude of the voltage signal, f is the actuating frequency of the actuating device and t is the actuating time of the actuating device. The driving signal received by the second actuating unit 22A and the driving signal received by the fourth actuating unit 22B are the second driving signals; the second driving signal is a voltage signal and is denoted by M sin (2πft+180°), wherein M is the amplitude of the voltage signal, f is the actuating frequency of the actuating device and t is the actuating time of the actuating device. The amplitude of the first driving signal and the amplitude of the second driving signal are the same, and the phase difference of the first driving signal and the second driving signal is 180°, i.e., the phase difference of the two driving signals of the first actuating unit 21A and the second actuating unit 22A of the wing-shaped actuator 20A is 180°, and the phase difference of the two driving signals of the third actuating unit 21B and the fourth actuating unit 22B of the wing-shaped actuator 20B is 180°.

As shown in FIG. 2, when the first actuating unit 21A and the third actuating unit 21B receive the first driving signals from the driving circuit DC1 (the first driving signal is at a high-level voltage for example), the first actuating unit 21A and the third actuating unit 21B become deformed and are bent downward and thus put strain on the supporting part 30A and 30B and the torsional part 40A and 40B, and the moment of force M1 is generated to drive the micro-mirror 10 to swing. The swinging level of the micro-mirror 10 is greater than the swinging level of the first actuating unit 21A and the swinging level of the third actuating unit 21B, i.e., the swinging level of the micro-mirror 10 is greater than the swinging level of the wing-shaped actuator 20A.

At the same time, the second actuating unit 22A and the fourth actuating unit 22B receive the second driving signals from the driving circuit DC1 (the second driving signal is at a low-level voltage for example), the second actuating unit 22A and the fourth actuating unit 22B become deformed and are bent upward and thus put strain on the supporting part 30A and 30B and the torsional part 40A and 40B, and likewise, the moment of force M1 is generated to drive the micro-mirror 10 to swing. The swinging level of the micro-mirror 10 is greater than the swinging level of the second actuating unit 22A and the swinging level of the fourth actuating unit 22B, i.e., the swinging level of the micro-mirror 10 is greater than the swinging level of the wing-shaped actuator 20B.

When the first actuating unit 21A and the third actuating unit 21B receive the first driving signals from the driving circuit DC1 (the first driving signal is at the low-level voltage for example), the first actuating unit 21A and the third actuating unit 21B become deformed and are bent upward and thus put strain on the supporting part 30A and 30B and the torsional part 40A and 40B. At the same time, the second actuating unit 22A and the fourth actuating unit 22B receive the second driving signals from the driving circuit DC1 (the second driving signal is at the high-level voltage for example), the second actuating unit 22A and the fourth actuating unit 22B become deformed and are bent downward and thus put strain on the supporting part 30A and 30B and the torsional part 40A and 40B, and the moment of force M2 is generated to drive the micro-mirror 10 to swing.

Because the first driving signal and the second driving signal are all periodic signals, the micro-mirror 10 periodically swings with respect to the axial line ax1 as the swinging axis.

In the actuating device of the embodiment, the wing-shaped actuator is bent upward by the subtle deformation and provides the pure torque to the micro-mirror, and thus, the micro-mirror swings due to the driving of the pure torque. The pure torque avoids the actuating device from generating a non-linear response to obtain a linear response, and the linear response augments the flexibility of the actuating device. Based on the linear response, when the actuating frequency of the actuating device approaches the frequency corresponding to the needed mode shape of the actuating device, the needed energy for swinging the micro-mirror is effectively focused on the surface of the micro-mirror and the torsional part so that the scanning angle of the actuating device may be magnified.

It should be noted that based on the linear response (linear response), the resonant frequency (i.e., the frequency of the actuating device at the maximum scanning angle) of the actuating device still remains unchanged at the different voltages, and the structure of the actuating device still remains stable at the maximum scanning angle. Based on the non-linear response, the resonant frequency of the actuating device would change with the different voltages, and the structure of the actuating device is unstable at the maximum scanning angle.

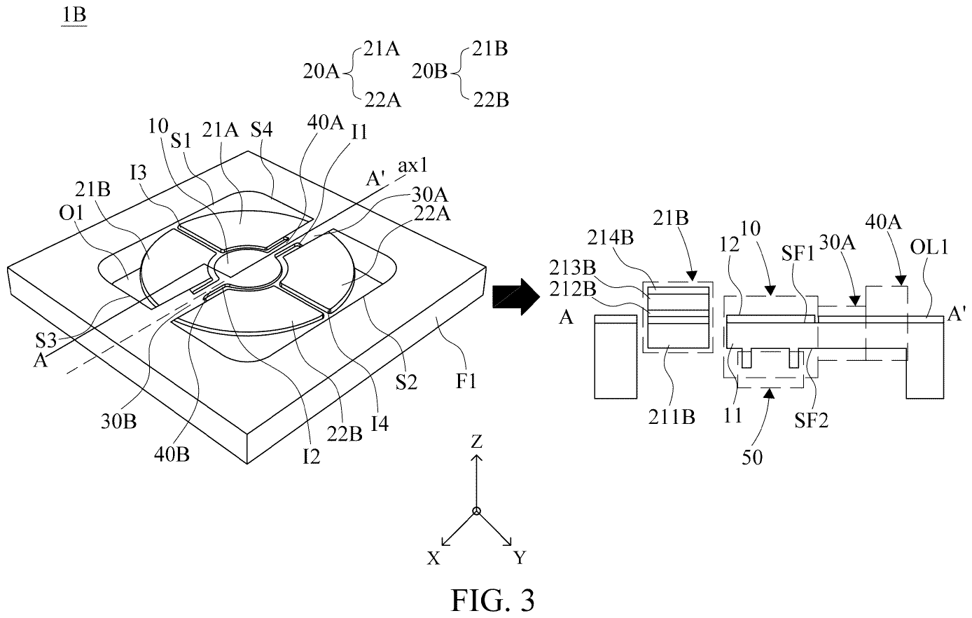

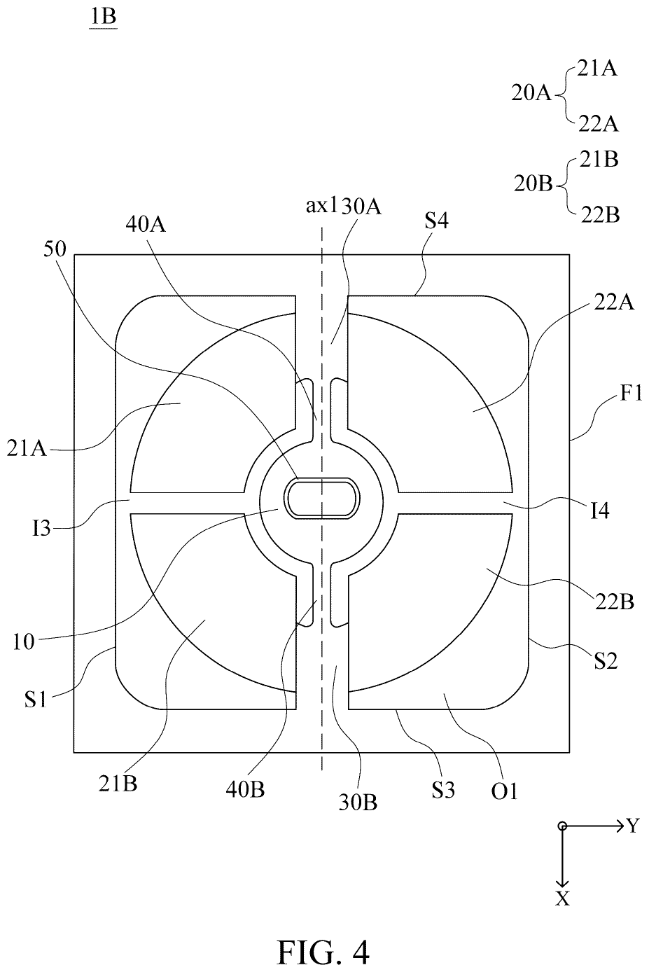

Please refer to FIG. 3 and FIG. 4, which depict a cross section diagram of an actuating device according to one embodiment of the disclosure and the bottom view diagram of the actuating device according to one embodiment of the disclosure. The difference between the actuating device 1B shown in FIG. 3 and FIG. 4 and the actuating device 1A shown in FIG. 1A to FIG. 1C: the micro-mirror 10 further includes a rib structure 50. In addition, the following will describe the detailed configurations of the micro-mirror 10 and the third actuating unit 21B, and the configurations of the first actuating unit 21A, the second actuating unit 22A and the fourth actuating unit 22B are the same as the configuration of the third actuating unit 21B and would not be repeated. The cross section diagram of the actuating device is the cross section diagram with respect to a line segment A-A′ as a section line.

The third actuating unit 21B includes a first substrate 211B, a first electrode 212B, a piezoelectric material layer 213B and a second electrode 214B. The first electrode 212B is disposed on the first substrate 211B, the piezoelectric material layer 213B is disposed on the first electrode 212B, the second electrode 214B is disposed on the piezoelectric material layer 213B; in other words, the first electrode 212B is disposed between the first substrate 211B and the piezoelectric material layer 213B, and the piezoelectric material layer 213B is disposed between the first electrode 212B and the second electrode 214B. The second electrode 214B is coupled to the driving circuit DC1 to receive the first driving signal, and for example, the first electrode 212B coupled to a ground terminal or to a fixed voltage. In one embodiment, an insulation layer OLI may be disposed between the first substrate 211B and the first electrode 212B to achieve the electrical insulation between the adjacent components. The insulation layer OLI may be SiO₂ for example.

The micro-mirror 10 includes a second substrate 11, a metal layer 12 and the rib structure 50. The second substrate 11 has a first surface SF1 and a second surface SF2 which are opposite to each other, and the second substrate 11 may be connected to the first substrate 211B by the supporting part and the torsional part for example. In one embodiment, the first surface SF1 and the upper surface of the first substrate 211B are coplanar for example, and the first substrate 211B, the second substrate 11, the substrate of the supporting part and the substrate of the torsional part are integrally formed for example, or the aforementioned substrates and the frame body may be integrally formed. The metal layer 12 is disposed on the first surface SF1 and is configured to reflect a beam for example. The rib structure 50 is disposed on the second surface SF2, and the shape of the orthogonal projection of the rib structure 50 on the second surface SF2 is annular. The height of the rib structure 50 is the distance between the bottom of the rib structure 50 located on the second surface SF2 and the top of the rib structure 50, and the distance between the first surface SF1 and the second surface SF2 is less than the height of the rib structure 50. By the rib structure 50, the rigidity of the micro-mirror 10 is augmented to reduce the dynamic deformation of the micro-mirror 10 during high-frequency scanning.

The first substrate 211B and the second substrate 11 may be silicon (Si) substrates. The materials of the metal layer 12, the first electrode 212B and second electrode 214B may be metal materials, and the metal materials may include In, Sn, Al, Au, Pt, In, Zn, Ge, Ag, Pb, Pd, Cu, AuBe, BeGe, Ni, PbSn, Cr, AuZn, Ti, W or TiW. The materials of the piezoelectric material layer 213A may be LiNbO₃, LiTaO₃, KNaNbO₃ (KNN), BaTiO₃, PbTiO₃ or Pb(ZrTi)O3 (PZT).

According to the above description, in the actuating device of the disclosure, the pure torque is provided to the micro-mirror to drive the micro-mirror to swing by the configurations of the two wing-shaped actuators, the supporting part and the torsional part, thereby obtaining the linear response. Based on the linear response, the needed energy for swinging the micro-mirror is effectively focused on the torsional part so that the scanning angle of the actuating device may be magnified.

In addition, the actuating device of the disclosure further includes the rib structure to reduce the dynamic deformation of the micro-mirror 10 during swinging.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An actuating device comprising:
a micro-mirror swinging around an axial line; and
two wing-shaped actuators encompassing the micro-mirror, wherein each of the two wing-shaped actuators comprising:
two actuating units which are separate from each other and are respectively disposed on two sides of the axial line, wherein there is an interval between the two actuating units;
a supporting part, wherein at least one part of the supporting part is disposed in the interval and is connected to the two actuating units; and
a torsional part, wherein at least one part of the torsional part is disposed in the interval and is connected to the supporting part and the micro-mirror;
wherein, each of the four actuating units receives a driving signal to drive the micro-mirror to swing.

2. The actuating device according to claim 1, wherein the driving signals received by the actuating units on the same side of the axial line are same.

3. The actuating device according to claim 1, wherein a phase difference of the driving signals received by the two actuating units of each of the two wing-shaped actuators is 180 degrees.

4. The actuating device according to claim 1, wherein the two actuating units of each of the two wing-shaped actuators are symmetrically disposed with respect to the micro-mirror.

5. The actuating device according to claim 1, wherein each of the four actuating units comprises a first substrate, a first electrode, a piezoelectric material layer and a second electrode, the first electrode is disposed on the first substrate, the piezoelectric material layer is disposed on the first electrode, and the second electrode is disposed on the piezoelectric material layer.

6. The actuating device according to claim 5, further comprising a driving circuit coupled to the second electrode of the actuating unit to provide the driving signal; the first electrode is coupled to a ground terminal or to a fixed voltage.

7. The actuating device according to claim 1, wherein the micro-mirror comprises a second substrate, a metal layer and a rib structure, the second substrate has a first surface and a second surface which are opposite to each other, the metal layer is disposed on the first surface, the rib structure is disposed on the second surface, and a shape of orthogonal projection of the rib structure on the second surface is annular.

8. The actuating device according to claim 7, wherein a distance between the first surface and the second surface is less than a height of the rib structure.

9. The actuating device according to claim 1, wherein a width of the supporting part is greater than a width of the torsional part.

10. The actuating device according to claim 1, wherein the supporting part and the torsional part are located on the axial line, and the actuating units connected to the supporting part are separate.

11. The actuating device according to claim 1, further comprising a frame body with an accommodation opening, and the micro-mirror and the two wing-shaped actuators are disposed on the accommodation opening, and the supporting part is connected to the frame body.

12. The actuating device according to claim 1, wherein the two wing-shaped actuators are separate.

13. The actuating device according to claim 1, wherein a swinging level of the micro-mirror is greater than swinging levels of the two wing-shaped actuators.
